(19) United States
(12) Patent Application Publication
(10) Pub. No.: US 2010/0254585 A1
(43) Pub. Date: Oct. 7, 2010

(54) OVEREXPOSURE CORRECTION FOR LARGE VOLUME RECONSTRUCTION IN COMPUTED TOMOGRAPHY APPARATUS

(76) Inventors: Thomas Brunner, Nuernberg (DE); Bernd Schreiber, Forchheim (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/752,443

(22) Filed: Apr. 1, 2010

Related U.S. Application Data
(60) Provisional application No. 61/165,787, filed on Apr. 1, 2009.

(51) Int. Cl. G06K 9/00

(52) U.S. Cl. 382/131

(57) ABSTRACT

A method and system of processing medical images such as projection images of large volume structures obtained by two-pass scanning for generating three-dimensional images. Measured values of each image frame is calculated as an image line. Over-exposed portions of the image line are detected to at one end of the image line and then at the other end of the image line. A determination is made of the approximate center of the image line. A line integral of the image line is generated and then using an assumed shape the over-exposed portions are extrapolated. The processed image frames may then be combined to generate the three-dimensional image.

### CROSS-REFERENCE TO RELATED APPLICATION

This application claims the benefit of U.S. Provisional Patent Application Ser. No. 61/165,787, filed Apr. 1, 2009, which is incorporated by reference herein.

### BACKGROUND OF THE INVENTION

1. Field of the Invention

The present invention relates generally to method and apparatus for medical imaging, and more particularly to a method and apparatus for exposure compensation in a computed tomography imaging system.

2. Description of the Related Art

In medical imaging systems, a detector is used to detect signals generated by a signal source so that a medical image of a patient is obtained from the detected signals. Multi-axis imaging systems provide multiple axis positioning and movement of the signal source and signal detector in the imaging system. An example of a multi-axis imaging system is the Artis multi-axis medical imaging system of Siemens AG. The Artis multi-axis system uses an FD (Flat Detector technology) detector from the Trixell company. The FD detector has a dynamic range of 14 bits, which is relatively small when compared with the dynamic range of a CT (Computed Tomography) detector, which typically has a dynamic range between 18 and 20 bits.

A dynamic range of 14 bits is often not large enough to avoid over-exposure in 2D projection images obtained by the multi-axis system, which has a negative impact on 3D imaging that use the 2D projection images because the reconstructed density values (Hounsfield values) are too small. This is especially true for 3D images generated using the DynaCT angiography imaging system of Siemens. In addition to the over-exposure problem, one encounters so-called capping artifacts, for example even for a homogeneous object. The reconstructed Hounsfield values HU are not reduced by a simple DC offset, but become smaller and smaller towards the edges of the object.

FIG. 1 is a graph that shows a schematic illustration of Hounsfield values 10 resulting from imaging a homogeneous cylinder with a radius R, as indicated at 12. An over-exposure occurs with the result that the Hounsfield values of the reconstructed 3D data set is smaller and shows a capping effect as indicated by the line 14. Without the capping effect, the image of the cylinder should appear as a flat line, as shown for example at 16. Capping artifacts hinder or eliminate the possibility of detecting low contrast objects in the reconstructed images.

In 2005, an overexposure correction algorithm was introduced into the DynaCT reconstruction software on the Syngo X-Workplace image management platform which effectively reduces the capping artifacts for 3D reconstructions. A simple, reliable and object-dependent correction of overexposure for (angiographic) computed tomography is provided. See U.S. Pat. No. 7,546,493, entitled Method for Responding to Errors Occurring During Operation of a Networked Medical System.

However, the correction algorithm is not ideal for so-called 3D large volume image acquisitions which can be done with the Artis Zeego system (a robotic imaging system) and which is performed using two independent image runs. For imaging smaller volumes the object to be imaged is centered in the imaging beam, but for a 3D large volume acquisition the object is not centered in the acquired projections and instead the detector is rotated around the focus position to increase the field of view.

A 3D imaging process for a large volume object 18 is shown schematically in FIG. 2, where the imaging of the object is performed in two imaging runs. In particular, a first imaging run is shown in an end view at 20 in which the imaging beam 22 images a left lateral portion of the object 18 to be imaged using a beam directed to the left half of the object 18 and using a sensor 24 positioned in the beam path at an angle to the horizontal. The imaging system is set to 220 degrees rotation angle with the flat detector (FD) sensor 24 set to an eccentric left position aligned to the beam axis. The imaging run is in the forward direction, in other words the object 18 and imaging source/sensor are moved relative to one another in a forward direction.

A second imaging run is performed, as shown at 26, by directing the imaging beam 22 to the right lateral portion of the object 18. The flat detector (FD) sensor 24 is moved to the right and tilted to align it to the beam axis. The imaging system is set to 220 degrees eccentric right. For this second run, the object 18 and source/sensor are moved in the reverse or back direction as the beam moves along the right lateral side of the object 18.

After completion of the left side and right side imaging runs, the data of the two imaging runs are combined as indicated schematically at 28 so that the whole of the large volume object 18 has been imaged. The combined data is as if two imaging beams 22 and two detectors 24 were used in side-by-side arrangement.

As a consequence of combining the data from the two imaging runs, the acquired projection images are very strongly overexposed on one side, but not on the other side. In FIG. 3, for instance, an image 30 of an object 32 is shown. The object 32 here is a person's torso, which appears in the image strongly over-exposed on the left side 34 but not on the right side 36 of the image. The currently used over-exposure correction algorithm has problems dealing with this asymmetry in the imaging process and as a result creates artifacts at the edges of the object of interest. In particular, the edges 34 of the object 32 come out too bright in the image 30.

The bright edges can be seen in a combined image resulting from a two-pass imaging run as shown in FIG. 4. In particular, an image slice 40 through a torso of a person has been generated by a two pass imaging session to image the left side 42 and right side 44 separately and then the two images are combined to form a single image 46. An arrow 48 indicates an over-exposed edge 50 of the image slice. The over-exposed portions 50 appear at the upper outside surface portions at both sides of the image slice 46.

A method for reconstructing three dimensional images from a number of two dimensional projection images is described in Schreiber et al U.S. Patent Application Publication No. US 2007/0133748 A1.

### SUMMARY OF THE INVENTION

The present invention provides an over-exposure correction method and system which is suited for three-dimensional large-volume image acquisitions using multiple imaging passes, but can also be used for standard 3D acquisitions that are obtained, for example, by a single pass image acquisition. The present method and system provides good contrast resolution, together with low artifact levels, and thereby provides a substantial improvement in the reconstructed image quality.

The method and system make use of an algorithm for adjusting the exposure in an image to avoid over-exposed regions of the image. The algorithm may be embodied in software operating on a computer or computerized device or system having one or more microprocessors and having tangible computer readable media on which the software is stored. The algorithm may be embodied in a system including hardware and software and/or firmware which carries out the processing of the image data. The algorithm is also embodied in methods for over-exposure correction.

### BRIEF DESCRIPTION OF THE DRAWINGS

FIG. 1 is a graph showing Hounsfield values in a reconstruction of 3D data from imaging of a homogenous cylinder according to the prior art;

FIG. 2 is a schematic representation of a two-pass imaging run of a large volume object, and the resulting combined image of the object according to the prior art;

FIG. 3 is a two-dimensional radiographic image frame of a left side of a human torso as an example of a large volume object showing shadowing to one side of the image and over-exposure to the other side according to the prior art;

FIG. 4 is an image slice of a reconstructed three-dimensional image of a large volume object obtained by two pass imaging;

FIG. 5 is a schematic representation of an object to be imaged showing the effects of density on image intensity;

FIG. 6 is a graph showing signal intensity levels of an imaging scan in which clipping of the signal occurs at the edges of the object due to over-exposure;

FIG. 7 is a graph showing signal intensity levels of an imaging scan in which intensity values have been extrapolated to provide to increase the dynamic range of the signal of the image data according to the principles of the present invention;

FIG. 8 is a pair of reconstructed axial slices of an ellipsoidal cylinder that has been imaged using two-pass three-dimensional imaging, wherein the image to the left has been processed using the prior over-exposure correction method and the image to the right has been processed using the present over-exposure correction method;

FIG. 9 is a pair of reconstructed axial slices of a human torso that have been imaged using two-pass three dimensional imaging, wherein the image to the left has been processed using the prior over-exposure correction method and the image to the right has been processed using the present over-exposure correction method;

FIG. 10 is a pair of reconstructed axial slices of a human torso that have been imaged using two-pass three dimensional imaging, where the image to the left was processed using the prior over-exposure correction method and the image to the right was processed using the present over-exposure correction method;

FIG. 11 is a pair of reconstructed axial slices of a human torso that have been imaged using two-pass three dimensional imaging, where the image to the left has been processed using the prior over-exposure correction method and the image to the right has been processed using the present over-exposure correction method;

FIG. 12 is a pair of reconstructed axial slices of a human torso that have been imaged using two-pass three dimensional imaging, where the image to the left has been processed using the prior over-exposure correction method and the image to the right has been processed using the present over-exposure correction method;

FIG. 13 is a pair of reconstructed axial slices of a human torso that have been imaged using two-pass three dimensional imaging, where the image to the left have been processed using the prior over-exposure correction method and the image to the right have been processed using the present over-exposure correction method;

FIG. 14 is a flow diagram of an embodiment of the present method; and

FIG. 15 is a schematic representation of the computer system with examples of medical scanners for carrying out the present method.

### DETAILED DESCRIPTION OF THE PREFERRED EMBODIMENTS

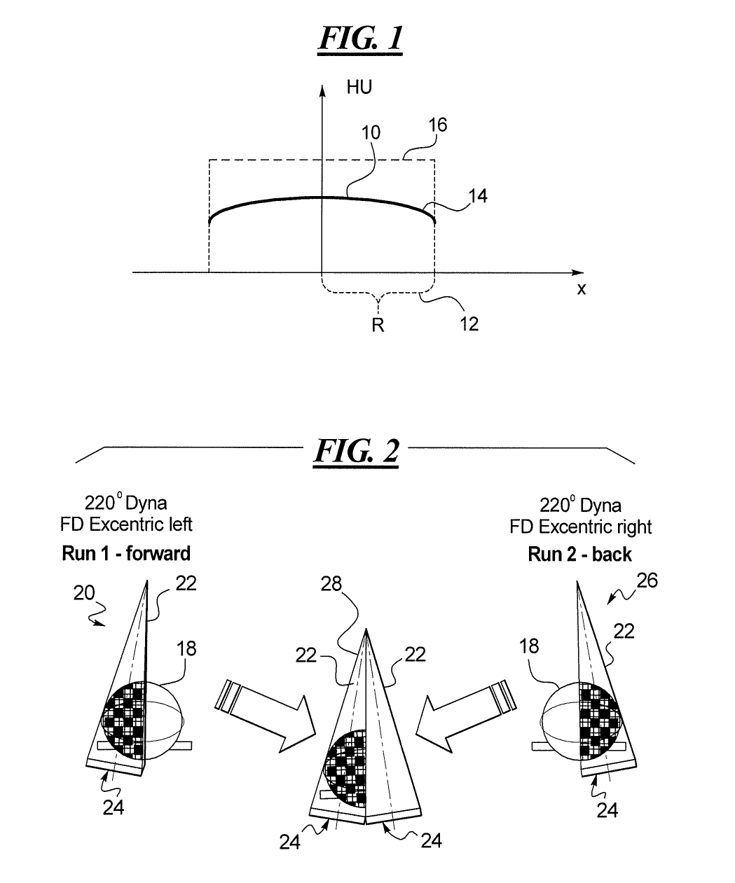

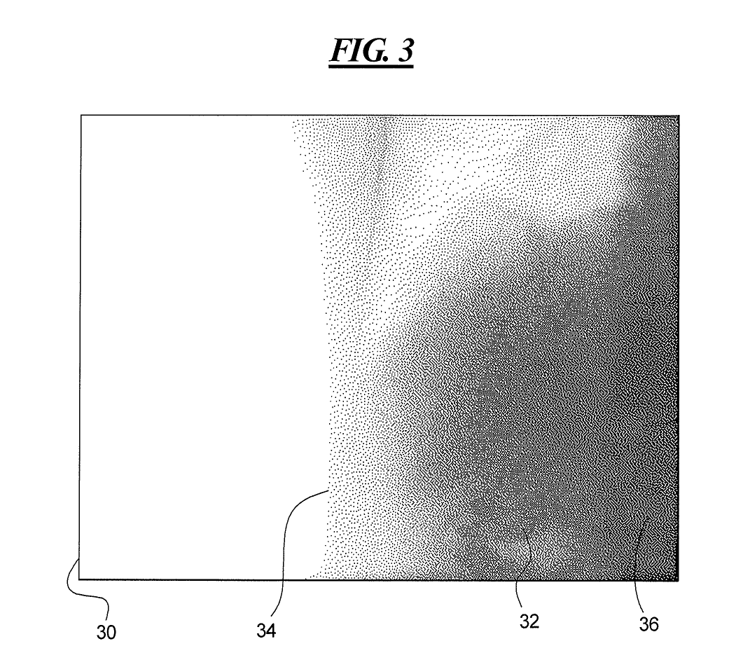

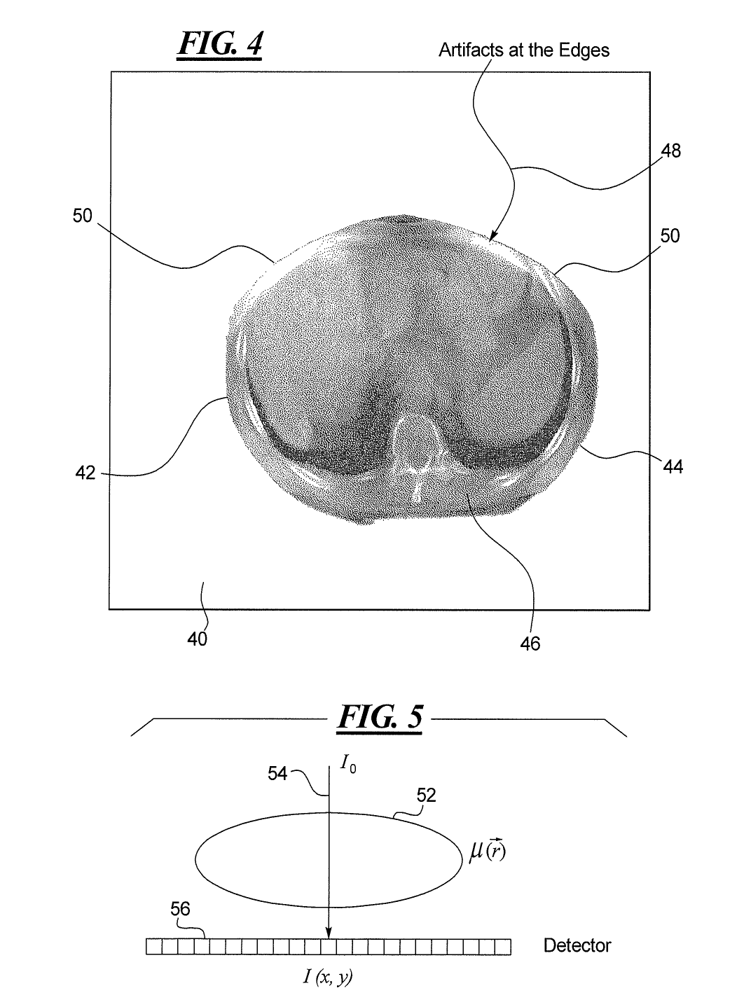

There is shown in FIG. 1 a graph showing capping effects at the edges of a projection image, as described in greater detail above. FIG. 2 is a schematic illustration of two pass imaging process for imaging a large volume object, as described above. FIG. 3 is an X-ray image of one side of a human torso showing that the left side of the image is lighter than the right side, as described above. FIG. 4 is an image slice of a reconstructed three-dimensional image obtained by two-dimensional projection imaging in two passes, as described in the foregoing.

Over-exposure correction according to the present method and system is determined according to an algorithm. The algorithm is performed by a programmed computer device or system. The algorithm uses values illustrated in FIG. 5. An object to be imaged is represented by a gray shaded oval that has a density μ(\vec{r}). The intensity of the imaging beam is Iₒ as shown by arrow 54 and a detector 56 is operable to sense the intensity of the beam as I(x,y) after passing through the object 52. The input for the reconstruction algorithms must be line integrals p(x,y)=∫μ(\vec{r})ds of the object of interest. Line integrals are defined as follows:

$$p ( x , y ) = \int μ ( {r}^{->} ) d s = ln ( \frac{{I}_{0}}{I ( x , y )} ) ,$$

where Iₒ is the maximum intensity when no object is present and I(x,y) is the measured intensity after the imaging ray has passed through the object, see FIG. 5. The measured gray values g(x,y) in the 2D projection images and the maximum gray value g₀(λ) correspond to I(x,y) and I₀:

g(x,y)∝ln(I(x,y)),

g₀(λ)∝ln(I₀)

Images are acquired as a sequence of two-dimensional projection images or frames along a length of the object to be imaged. The variable lambda (λ) denotes the sequence number of the image frame, counting the two-dimensional projection images. The image frames in the sequence may be referred to as images labeled by lambda (λ). Since the imaging system permanently readjusts tube voltage, tube current and pulse width of the x-ray source, for every projection labeled by λ, the value g₀(λ) will change. The relation between g(x,y) and p(x,y) can be expressed as

$$p ( x , y ) = \frac{{g}_{0} ( λ ) - g ( x , y )}{α} ,$$

where α is a constant. The expression g₀(λ) corresponds to an intensity which is often larger than the maximum possible value of the detector. Therefore, the 2D projection images can be clipped at the edges, which leads to artifacts in the reconstructed 3D datasets as discussed above.

The present method uses an algorithm for overexposure correction, also referred to as an overexposure correction algorithm, which is optimized for three-dimensional large volume acquisitions, for example with the Artis Zeego imaging system, but can also be used for standard 3D acquisitions using other imaging systems, for example.

First, the gray value g0 (log(I_{—}0)) is calculated. Two dimensional images are acquired frame-by-frame and each frame is labeled with a sequence number lambda (λ). For instance, if 400 frames of two-dimensional projection images are acquired, the lambda value for the first frame is 1, for the second frame lambda is 2, and for the last frame lambda value is 400. Every projection image acquired in the sequence is processed. A calculation of g₀(λ), which is the gray value when no object is present, is performed. This value can be substantially larger than the maximum possible value of the detector.

A detection of overexposure on the left side of an image line is performed. Every image line of a projection image labeled by λ is investigated, and a determination is made if there is clipping on the left side. Since there can be shadow zones due to the left edge of the collimator, the investigation begins with the pixels whose index is smaller than the value Left_Border, with

Left_Border=Collimator_Left_Vertical_Edge+Left_Border_Offset,

where Collimator_Left_Vertical_Edge is contained in the DICOM header information of the 2D projection data set and Left_Border_Offset is specified in a configuration file. If at least one of those pixels has a gray value which is larger than a predefined threshold τ (which is specified in a configuration file), overexposure has been detected on the left side of the image line and a determination is made of the pixel x, where the clipping ends.

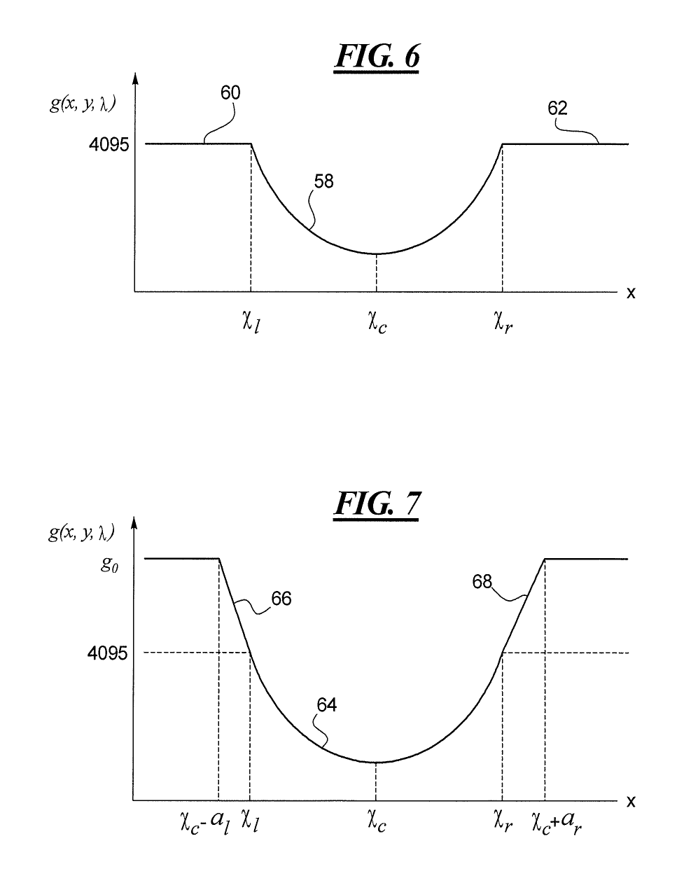

In FIG. 6, a line 58 shows intensity values of a projection image in a smooth curve to a left edge of the object at the pixel xₗ, where clipping occurs at value 4095 as shown by the flat line 60, and to the right edge of the object at pixel xᵣ, where clipping also occurs at value 4095 as shown by the flat line 62. The detection of where clipping ends is determined by

g(xₗ−1)>=τ₂ g(xₗ)<τ₂,

with a predefined threshold τ₂. If such a pixel is not found, an assumption is made that there is no absorbing object in the image line, the whole image line is set to g₀(λ) and the processing continues with the next image line. If clipping is found at the left side, then for all pixels which lie on the left side from the pixel xₗ from where clipping ends, gray values are extrapolated.

A detection of overexposure on the right side of an image line is performed. Every image line of a projection image labeled by λ is examined to determine if there is clipping on the right side. Since there can be shadow zones due to the right edge of the collimator, an investigation is performed of the pixels whose index is larger than Right_Border, with

Right_Border=Collimator_Right_Vertical_Edge−Right_Border_Offset,

where the value Collimator_Right_Vertical_Edge is contained in the DICOM header of the 2D projection data set and Right_Border_Offset is specified in a configuration file. If at least one of those pixels has a gray value which is larger than the predefined threshold overexposure has been detected on the right side of the image line and a determination is made of the pixel xᵣ where the clipping ends. This is represented by the line 62 in FIG. 6. The clipping is found by

g(xᵣ+1)>=τ₂ g(xᵣ)<τ₂,

with a predefined threshold τ₂. If one cannot find such a pixel, the whole line is set to g₀(λ) and the process continues with the next line.

The object being imaged is presumed to be an ellipsoid according to an embodiment of the invention. Other shapes can be assumed as well where appropriate. A first guess is made as to the center pixel of the ellipsoid. If there is either an overexposure on the left side or an overexposure on the right side, a determination is made of the center pixel x_{c} which is a first guess of the center of an extrapolated ellipsoid. Calculation of the center pixel is provided for three cases:

a. If an overexposure is found on the left side and on the right side of the image line, the center pixel is found by:

$${x}_{c} := \frac{{x}_{1} + {x}_{r}}{2}$$

b. If an overexposure is found only on the left side of the image line, and
(i) if the acquisition is not a 3D large volume acquisition, the center pixel is found by:

$${x}_{c} = \frac{{x}_{1} + {N}_{x}}{2} , or$$

(ii) if the acquisition is a 3D large volume acquisition, the center pixel if found by:

$${x}_{c} = Collimator\_Right \_Vertical \_Edge - 1 - \frac{ζ \cdot overlap}{2 \cdot pixelsize}$$

where ζ is a parameter (with a default value of 1) and overlap is the detector overlap of the two runs of the 3D large volume acquisition.

c. If an overexposure is found only on the right side of an image line, and
(i) if the acquisition is not a 3D large volume acquisition, the center pixel is found by:

$${x}_{c} = \frac{{x}_{r}}{2} , or$$

(ii) if the acquisition is a 3D large volume acquisition, the center pixel if found by:

$${x}_{c} = Collimator\_Left \_Vertical \_Edge + 1 = \frac{ζ \cdot overlap}{2 \cdot pixelsize} .$$

Afterwards, a determination is made of a gray value of the center pixel x_{c}:

g_{c}:=g(x_{c}).

Having defined the gray value of the center pixel x_{c} (see FIG. 6) its corresponding line integral p_{c} is defined:

$${p}_{c} := p ( {x}_{c} ) = \frac{{g}_{0} ( λ ) - {g}_{c}}{α} .$$

An extrapolation of gray values on the left side of an image line is performed. If there is clipping on the left side of an image line yⱼ, an assumption is made of an ellipsoidal shape of the object and for the line integrals:

$$p ( x ) = {p}_{c} \cdot \sqrt{1 - \frac{{( x - {x}_{c , adjusted} )}^{2}}{{a}_{1}^{2}}} .$$

This formula contains two parameters, namely x_{c,adjusted} and aₗ which have to be determined. These parameters are determined by demanding that the following two relations are fulfilled:

$$a ) {p}_{l} := p ( {x}_{l} ) = {p}_{c} \cdot \sqrt{1 - \frac{{( {x}_{l} - {x}_{c , adjusted} )}^{2}}{{a}_{1}^{2}}} , \\ b ) {p}_{1}^{′} := {p}^{′} ( {x}_{1} ) = - \frac{{p}_{c} \cdot ( {x}_{1} - {x}_{c , adjusted} )}{{a}_{1}^{2} \sqrt{1 - \frac{{( {x}_{1} - {x}_{c , adjusted} )}^{2}}{{a}_{1}^{2}}}}$$

This means that the extrapolation is done in such a way that both the line integral pₗ and also its first derivative p′ₗ are extrapolated in a continuous way. The parameter pₗ is known from the projection image and its first derivative p′ₗ can be easily calculated (for example, by a finite difference). From the formulas a) and b) we get for the first unknown parameter x_{c,adjusted}:

$${x}_{c , adjusted} = {x}_{1} + \frac{( {p}_{c}^{2} - {p}_{1}^{2} )}{{p}_{1} \cdot {p}_{1}^{′}}$$

and for the second unknown parameter aₗ:

$${a}_{1} = \frac{\vert {x}_{c , adjusted} - {x}_{1} \vert}{\sqrt{1 - \frac{{p}_{1}^{2}}{{p}_{c}^{2}}}} .$$

Plausibility checks for the values p′ₗ and x_{c,adjusted} should be done. The value p_{c}, which is the line integral of the ellipsoid at its center, has been determined above and is not readjusted further, since its value depends only weakly on the exact position of the center pixel x_{c}.

Finally, an extrapolation is performed for p(x) at the left side of xₗ in the following way:

$$p ( x ) = {P}_{c} \cdot \sqrt{1 - \frac{{( x - {x}_{c , adjusted} )}^{2}}{{a}_{1}^{2}}} , if x < {x}_{l} ⋀ x \geq ( {x}_{c , adjusted} - {a}_{l} ) . \\ 0 , if x < {x}_{l} ⋀ x < ( {x}_{c , adjusted} - {a}_{l} )$$

The corresponding gray values are:

g(x,yⱼ)=g₀(λ)−α·p(x).

In this example, an extrapolation is performed of gray values on the right side of an image line. If there is clipping on the right side of an image line yⱼ, again an assumption is made that the object is of an ellipsoidal shape and therefore for the line integrals:

$$p ( x ) = {p}_{c} \cdot \sqrt{1 - \frac{{( x - {x}_{c , adjusted} )}^{2}}{{a}_{r}^{2}}} .$$

This formula contains two parameters, namely x_{c,adjusted} and aᵣ which have to be determined. This is done by demanding that the following two relations are fulfilled:

$$a ) {p}_{r} := p ( {x}_{r} ) = {p}_{c} \cdot \sqrt{1 - \frac{{( {x}_{r} - {x}_{c , adjusted} )}^{2}}{{a}_{r}^{2}}} , and \\ b ) {p}_{r}^{′} := {p}^{′} ( {x}_{r} ) = - \frac{{p}_{c} \cdot ( {x}_{r} - {x}_{c , adjusted} )}{{a}_{r}^{2} \sqrt{1 - \frac{{( {x}_{r} - {x}_{c , adjusted} )}^{2}}{{a}_{r}^{2}}}}$$

This means that the extrapolation is done in such a way that both the line integral pᵣ and also its first derivative p′ᵣ are extrapolated in a continuous way. The parameter pᵣ is known from the projection image and its first derivative p′, can be easily calculated (for example, by a finite difference). From that we get for the first unknown parameter x_{c,adjusted}:

$${x}_{c , adjusted} = {x}_{r} + \frac{( {p}_{c}^{2} - {p}_{r}^{2} )}{{p}_{r} \cdot {p}_{r}^{′}}$$

and for the second unknown parameter aᵣ:

$${a}_{r} = \frac{\vert {x}_{c , adjusted} - {x}_{r} \vert}{\sqrt{1 - \frac{{p}_{r}^{2}}{{p}_{c}^{2}}}} .$$

Plausibility checks for p′ᵣ, and x_{c,adjusted} should be done. The value p_{c}, which is the line integral of the ellipsoid at its center, has been determined above and is not readjusted further, since its value depends only weakly on the exact position of x_{c}.

Finally, an extrapolation is performed of p(x) on the right side of x, in the following way:

$$p ( x ) = \{ \begin{matrix}{p}_{c} \cdot \sqrt{1 - \frac{{( x - {x}_{c , adjusted} )}^{2}}{{a}_{r}^{2}}} , & \begin{matrix}if x > {x}_{r} ⋀ x \leq \\ ( {x}_{c , adjusted} + {a}_{r} )\end{matrix} \\ 0 , & \begin{matrix}if x \geq {x}_{r} ⋀ x > \\ ( {x}_{c , adjusted} + {a}_{r} ) ,\end{matrix}\end{matrix}$$

The corresponding gray values are:

g(x,yⱼ)=g₀(λ)−α·p(x).

Afterwards, the process continues with the next image line.

The extrapolation of gray values is schematically depicted in FIG. 7. In FIG. 7 the gray scale values g as shown by line have been extrapolated beyond the left most non-clipped pixel xₗ at a value of 4095 to a further left pixel x_{c}-aₗ at a gray value of g₀. The additional gray values at line portion 66 have been added. Similarly, the gray values are extrapolated beyond the right most non-clipped pixel xᵣ to a pixel x_{c}-aᵣ at a gray value of g₀ to add gray values at line portion 68.

The calculations make an assumption that the volume being imaged has an ellipsoidal shape in cross section, which is not strictly true when imaging patient body structures, although the approximation is close in many instances. It is envisioned to perform a calculation based other assumed shapes of the object being imaged. For example, a modified ellipsoid type shape that provides a closer approximates a human torso may be used.

The calculations result in an effective increase in the dynamic range of the sensor data after processing. Where the overexposure has caused a loss of information in the actual sensor data, however, the present method does not recover this lost information. Nevertheless, the reconstructed image slices contain information that has heretofore not been visible in the image to the medical professional.

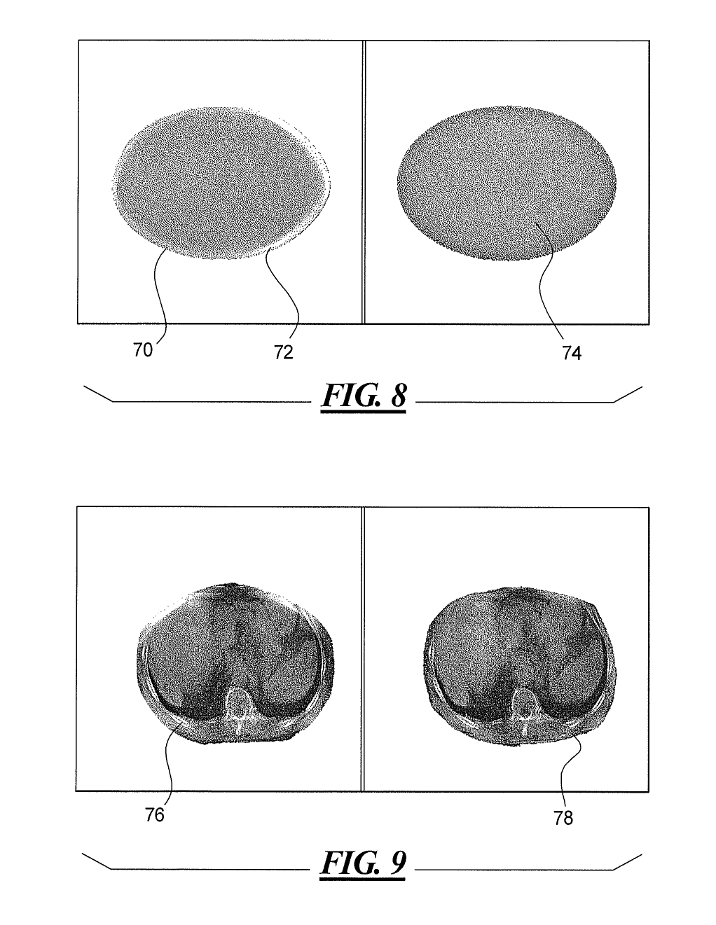

The results of the calculations are shown first for a simulation. The simulation is a simulated 2D projection image of an ellipsoidal cylinder that has main axes of 25.5 cm and 36 cm for a 3D large volume acquisition. The synthetic, or simulated, projection images are overexposed. The images are based on two imaging runs, an overlap of 50 mm between the two runs, an angular coverage is 220°, and an angular increment is 1°. The result of the reconstruction can be seen in FIG. 8. The projection image data was first processed using the prior over-exposure correction method. The result of the prior method is shown as image slice 70 on the left side of FIG. 8. Edges 72 of the ellipsoid are bright and overexposed so that detailed information is hidden or lost from the image. The overexposed areas are referred to as artifacts in the image. The projection image data was processed again, this time using the present overexposure correction method, and the resulting image is shown in FIG. 8 on the right side as image slice 74. The artifact levels at the edges of the object are substantially reduced.

The present method was applied to clinical data. Several clinical 3D large volume acquisitions were performed and analyzed as reconstructions using the prior overexposure correction method and the present method. In all cases the new overexposure correction method performed better and the artifact level at the edge of the patient was reduced. In FIG. 9 to FIG. 13, the results of the clinical comparisons are shown. Testing of the present method has shown that not only are overexposed areas at the outer edges of an image slice reduced or eliminated, but artifacts that appear deep inside the three dimensional volume dataset, such as where density values are low or there are cupping artifacts, are corrected.

In FIG. 9, the image slice 76 to the left has bright overexposed edges to the upper left and upper right of the patient's torso. The bright areas are eliminated from the same image data when processed according to the present method, as shown in the image slice 78 to the right. The bright overexposed areas in the lower left portion of the image slice are also reduced. Detail that is obscured in the left image 76 is visible in the right image 78.

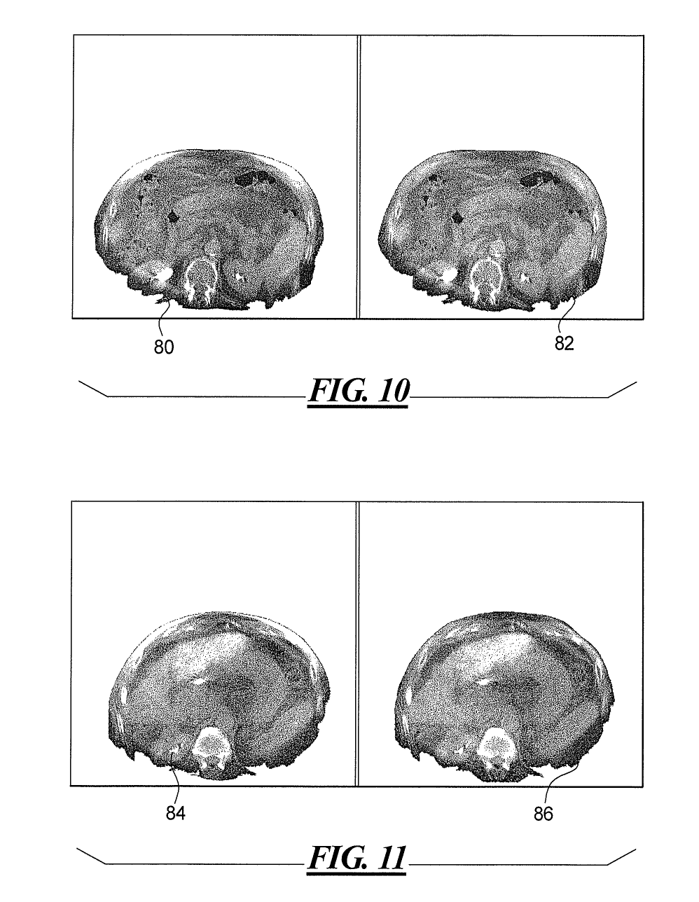

Another reconstructed image slice is shown in FIG. 10, also processed according to the prior overexposure method to the left 80 and according to the new overexposure correction method to the right 82. Overexposed regions in the reconstructed image are reduced in the new method. Anatomic structures can be seen in image 82 that are not visible in the reconstructed slice 80. A similar result is apparent in the reconstructed image slice of FIG. 11, where the image 84 is processed according to the prior method and the image slice 86 is processed according to the present method.

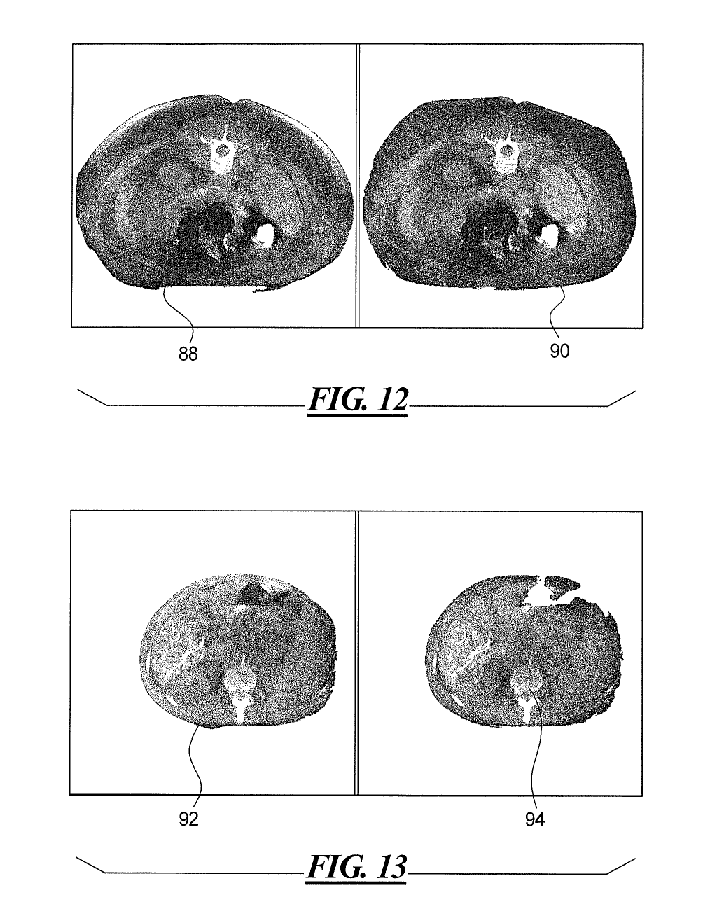

In FIG. 12, overexposed edges in the image slice 88 on the left are no longer present in the image slice 90 to the right. FIG. 13 also shows the result of the present image processing method. Overexposed areas on the lower left of the slice in image 92 are corrected in image 94 so that details may be better viewed in the image resulting from the present method. A portion of the image 94 to the upper right of the slice is less visible which appears as openings in the torso.

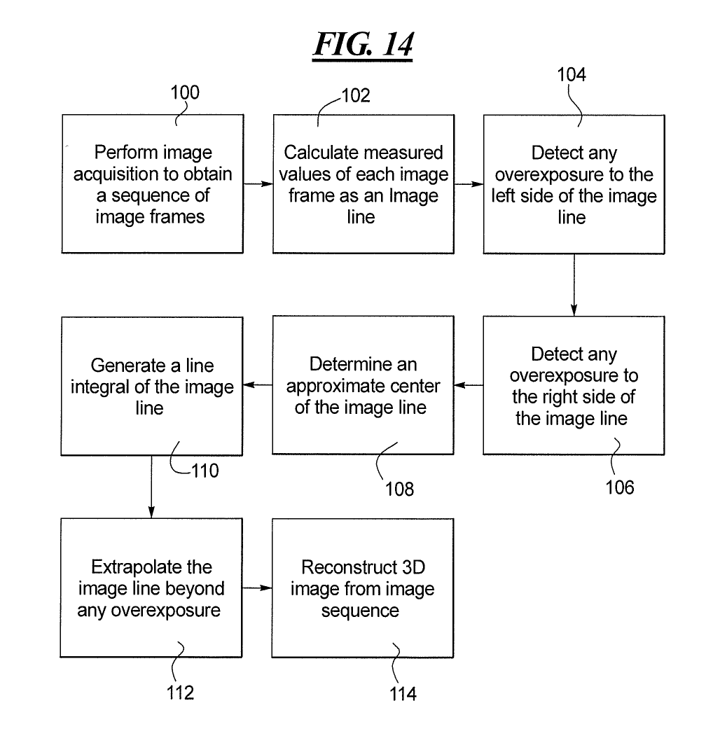

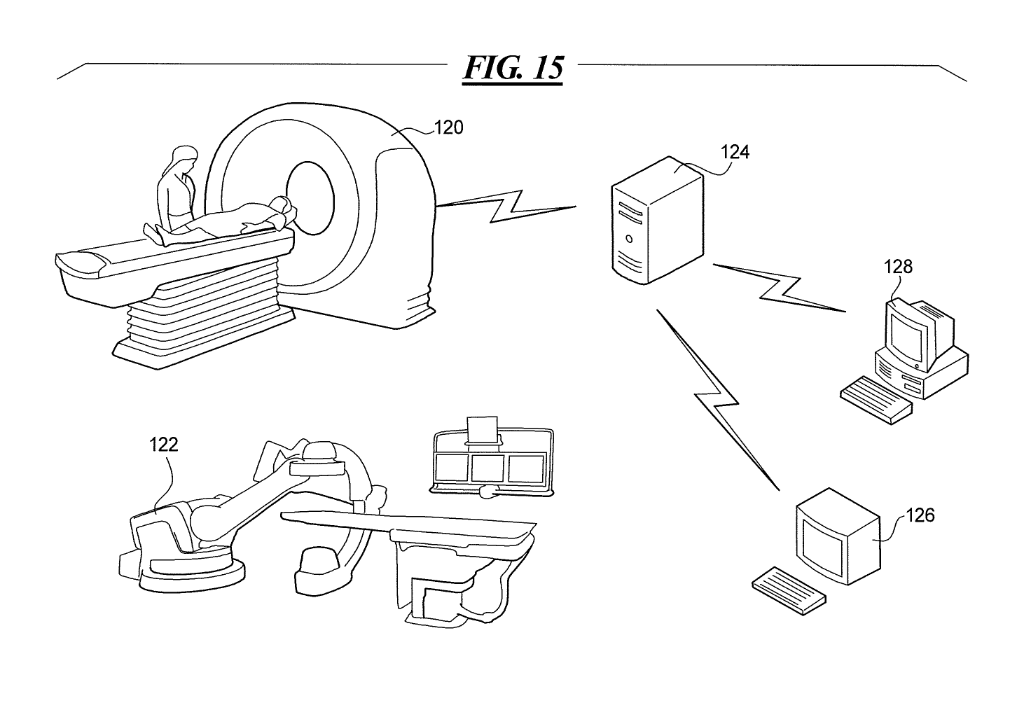

FIG. 14 shows steps in an embodiment of the present method. In step 100, an image acquisition is performed to obtain a sequence of image frames. The image acquisition can be performed shortly before the further steps or the further processing steps can be performed on stored or archived image data that has been obtained previously. The preferred method then calculates measured values of each image frame to define a line function of the values, at step 102. The line function is checked for any over-exposure to at one side of the image, here the left side of the image, at step 104. The line function is then checked for any over-exposure to the other side of the image, here the right side of the image, at step 106. In step 108 a determination is made of an approximate center of the object. As noted above, the measures taken to determine the center depend on whether an over-exposure is found on one or both sides of the image line. In step 110, a line integral is generated for the image line. The generation of the line integral may also generate the first derivative of the line function. In step 112, an extrapolation of the line beyond the over-exposed ends is performed. In step 114, the image line with the extrapolated values is used to reconstruct the three dimensional structures of the object being imaged.

It is envisioned that a system, such as a computer system, using the present overexposure correction method may have a user selectable control to apply the correction processing to image data or not. The computer system may also include a user control to permit user selection of the present correction processing method or other image processing methods so that the desired features in the image are shown at their best.

Advantages of the present method and system include better homogeneity of reconstructed slices, thereby enabling better 3D reconstructed image quality for C-arm X-ray systems, especially for low contrast resolution (DynaCT), and for cone-beam tomography in general.

The present method is performed on image frames obtained by a medical imaging system such as a computer tomography 120 as shown in FIG. 15. In a preferred embodiment, the medical imaging system is a C-arm imaging system as shown at 122. Image data is transmitted to a server 124 for storage. A computer terminal 126 or computer system 128 retrieves the image data and is programmed to perform the calculations of the present method as well as the calculations necessary to transform the projection image data into three-dimensional image data that represents the physical structures of the patient. The resulting image data may be stored, for example on the server, and displayed to a user on a display device of the computer terminal 126 or computer system 128 or other display device for viewing the medical professional to make a determination as to the condition of the patient who's body structures are shown. The computer 126 or computer system 128 includes one or more microprocessors for performing the calculations of the invention according to software operating on the computer. The software is stored on a tangible computer readable media, such as a computer hard drive of the server 124 or the computer system 128. The image data is also stored on computer readable media in the server 124 or computer system 128. The computer system 128 may be a stand-alone computer device, but more commonly is a networked computer device connected to other computer devices and systems through one or more networks, including possibly being connected to the Internet. The software and/or image data may be stored locally or on a server on the network, or may be stored on the network on so-called cloud storage.

Thus, there has been shown and described a system and method that overcomes problems resulting from clipping in a medical image, particularly in a medical image obtain by two-pass scanning.

Although other modifications and changes may be suggested by those skilled in the art, it is the intention of the inventors to embody within the patent warranted hereon all changes and modifications as reasonably and properly come within the scope of their contribution to the art.

We claim:

1. A method for imaging a patient, comprising the steps of:
scanning a first portion of the patient to obtain a first scanned image;
determining a location of a border of the scanned image;
add a border offset to the first scanned image;
investigating image lines of the first scanned image to find clipping;
determining a location in the first scanned image where clipping ends;
scanning a second portion of the patient to obtain a second scanned image;
investigating image lines of the second scanned image;
determining a location in the second scanned image where clipping ends;
combining the first scanned image and the second scanned image to provide a combined image;
defining a center of a volume approximating the portions of the patient scanned in the first and second scanning steps; and
extrapolating image element values in the combined image to generate image element values for image elements that are located beyond locations where the clipping ends.

2. A method as claimed in claim 1, wherein said step of extrapolating includes extrapolating values of image elements of the combined image with a projection value of the volume approximating the portions of the patient scanned in the scanning steps.

3. A method for imaging a large volume using a computed tomography apparatus, comprising the steps of:
imaging a first portion of the large volume to obtain a first image data file using a sensor of the computed tomography apparatus;
investigating image lines in the first image data file to find clipping in the first image data file;
imaging a second portion of the large volume to obtain a second image data file using the sensor of the computed tomography apparatus, said first portion of the large volume being adjacent to said second portion;
investigating image lines of the second image data file to find clipping in the second image file;
combining said first image data file and said second image data tile to produce a combined image file as an image of the large volume;
defining a center of an assumed shape approximating the large volume;
extrapolating image element values in the combined image file by applying the assumed shape to generate image element values for image elements that are disposed in a region of the image data file having clipping; and
displaying the combined image data with the extrapolated image element values in place of the clipped image element values.

4. A method for processing a two-pass medical image of a body, comprising the steps of:
scanning a first portion of the body in a first scanning pass to generate first pass image frames;
identifying clipping in the first pass image frames;
scanning a second portion of the body in a second scanning pass to generate second pass image frames;
identifying clipping in the second pass image frames;
combining said first and second pass image frames;
determining an approximate center of the combined image frames; and
interpolating image values for clipped portions of the image frames based on an assumed geometric shape.
